(19) United States
(12) Patent Application Publication
(10) Pub. No.: US 2024/0348280 A1
(43) Pub. Date: Oct. 17, 2024

(54) SYSTEMS AND METHODS FOR REDUCING HARMONICS IN COMMUNICATION MODULES

(71) Applicant: SKYWORKS SOLUTIONS, INC., Irvine, CA (US)

(72) Inventors: Akshara Kankar, Leander, TX (US); Nan Wu, Irvine, CA (US); Yiliu Wang, Irvine, CA (US)

(21) Appl. No.: 18/627,524

(22) Filed: Apr. 5, 2024

Related U.S. Application Data
(60) Provisional application No. 63/458,504, filed on Apr. 11, 2023.
(60) Provisional application No. 63/550,656, filed on Feb. 7, 2024.

(51) Int. Cl. H04B 1/48; H04B 1/00

(52) U.S. Cl. CPC H04B 1/48; H04B 1/006

(57) ABSTRACT

Aspects of the disclosure provide a front-end module for a wireless device comprising a front-end module for a wireless device. The front end module includes at least one transmit path configured to receive a first transmit signal, at least one receive path configured to receive a first receive signal, at least one transmit/receive path, coupled to the at least one receive path and the at least one transmit path, an antenna switching module coupled between the at least one transmit/receive path and an antenna port, and a first transmit filter located in the at least one receive path and configured to reduce harmonic content from the first transmit signal.

### CROSS-REFERENCE TO RELATED APPLICATIONS

This application claims priority under 35 U.S.C. § 119 (e) to U.S. Provisional Patent Application Ser. No. 63/458,504 titled “SYSTEMS AND METHODS FOR REDUCING HARMONICS IN COMMUNICATION MODULES,” filed Apr. 11, 2023, and to U.S. Provisional Patent Application Ser. No. 63/550,656 titled “SYSTEMS AND METHODS FOR REDUCING HARMONICS IN COMMUNICATION MODULES,” filed Feb. 7, 2024, the entire contents of which are incorporated herein by reference for all purposes.

### BACKGROUND

The present disclosure relates generally to communication modules. Some examples relate to systems and methods for reducing harmonics in communication modules.

### SUMMARY

According to at least one aspect of the present disclosure, a front-end module for a wireless device is provided comprising a front-end module for a wireless device including at least one transmit path configured to receive a first transmit signal, at least one receive path configured to receive a first receive signal, at least one transmit/receive path, coupled to the at least one receive path and to the at least one transmit path, an antenna switching module coupled between the at least one transmit/receive path and an antenna port and a first transmit filter located in the at least one receive path and configured to reduce harmonic content from the first transmit signal.

In the front-end module the first transmit filter may include an inductive/capacitive tank circuit, a capacitive element of the inductive/capacitive tank circuit may include a surface mount capacitor, and the capacitive element of the inductive/capacitive tank circuit may include an acoustic wave resonator. The front-end module may further include a transmit filter disposed in the transmit path, a receive filter disposed in the receive path, and a second transmit filter located in the transmit/receive path. The front-end module may be configured to support 5G wireless communication. The receive signal may be a mid band 5G signal. The first transmit signal may be a mid band 5G signal. The antenna switch module may be configured to selectively couple the transmit/receive path to the antenna port.

According to another aspect of the present disclosure a mobile communications device system is provided comprising a receive module, a first transmit module, a first transmit path coupled to the first transmit module and configured to receive a first transmit signal from the first transmit module, a receive path coupled to the receive module and configured to provide a receive signal to the receive module, at least one transmit/receive path, coupled to the receive path and the at least one transmit path, a first transmit filter located in the receive path and configured to reduce harmonic content from the first transmit signal. The mobile communications device system can include an antenna switching module coupled between the at least one transmit/receive path and an antenna port. The mobile communications device system can include a second transmit module and a second transmit path coupled to the second transmit module and to the at least one transmit/receive path, and the second transmit module may be configured to provide a second transmit signal to the second transmit path. In the mobile communication device system, the first transmit filter may be configured to reduce harmonic content from the second transmit signal, and the mobile communications device system may be configured to support 5G wireless communication. In the mobile communication device system, the receive module may include at least one low-noise amplifier. The mobile communications device system may further include a second transmit filter located in the transmit/receive path.

According to another aspect of the present disclosure a method is provided for controlling a front-end module for a wireless device including at least one transmit path to receive a first transmit signal, at least one transmit/receive path coupled to at least one antenna port, and an antenna switching module disposed in the at least one transmit path, the wireless device also including at least one receive path coupled to the at least one transmit/receive path. The method comprises using a filter disposed in the receive path, filtering at least one harmonic from the transmit signal, and controlling the antenna switching modules to route the transmit signal from the transmit/receive path to the antenna port.

The method may further include receiving a receive signal at the at least one antenna port and routing the receive signal to the receive path and through the filter in the receive path. The method may include receiving a second transmit signal on the transmit path and filtering at least one harmonic from the second transmit signal using the filter in the receive path. In the method, using a filter may include using a filter that includes an acoustic resonator.

According to another aspect of the present disclosure, a front-end module for a wireless device is provided comprising at least one transmit path configured to receive a first transmit signal, at least one receive path configured to receive a first receive signal, at least one transmit/receive path, coupled to the at least one receive path and to the at least one transmit path, an antenna switching module coupled between the at least one transmit/receive path and an antenna port, and a first transmit filter disposed between the at least one transmit path and a ground point.

In the front-end module, the first transmit filter may include an inductive/capacitive tank circuit, and a capacitive element of the inductive/capacitive tank circuit may include a surface mount capacitor. A capacitive element of the inductive/capacitive tank circuit may include an acoustic wave resonator. The front-end module may further include a transmit filter disposed in a first transmit path of the at least one transmit path, a receive filter disposed in a first receive path of the at least one receive path, and a second transmit filter disposed in a first transmit/receive transmit path of the at least one transmit/receive path, and the front-end module may be configured to support 5G wireless communication. In the front-end module the receive signal may be a mid band 5G signal, and the first transmit signal may be a mid band 5G signal. In the front-end module the antenna switch module may be configured to selectively couple the transmit/receive path to the antenna port.

According to another aspect of the present disclosure, a front-end module for a wireless device is provided comprising at least one transmit path configured to receive a first transmit signal, at least one receive path configured to receive a first receive signal, at least one transmit/receive path, coupled to the at least one receive path and to the at least one transmit path, an antenna switching module coupled between the at least one transmit/receive path and an antenna port, and a transmission line disposed in a first receive path of the at least one receive path and configured to present a short circuit to a harmonic signal of the first transmit signal to shunt the harmonic signal to the first receive path.

The front-end module may further include a transmit filter disposed in a first transmit path of the at least one transmit path, a receive filter disposed in the first receive path of the at least one receive path, and a second transmit filter disposed in a first transmit/receive path of the at least one transmit/receive path. The front-end module may be configured to support 5G wireless communication, the receive signal may be a mid band 5G signal, and the first transmit signal may be a mid band 5G signal. The antenna switch module may be configured to selectively couple the transmit/receive path to the antenna port.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 illustrates a block diagram of a mobile device according to an example;

FIG. 2 illustrates a block diagram of a front-end module system according to an example;

FIG. 3 illustrates a block diagram of a front-end module system according to an example;

FIG. 4 illustrates a graph showing results of a filter used in the example of FIG. 3;

FIG. 5 illustrates a graph showing additional results of the filter used in the example of FIG. 3;

FIG. 6 illustrates a block diagram of a front-end module system according to an example;

FIG. 7 illustrates a block diagram of a front-end module system according to an example; and

FIG. 8 illustrates a block diagram of a front-end module system according to an example.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

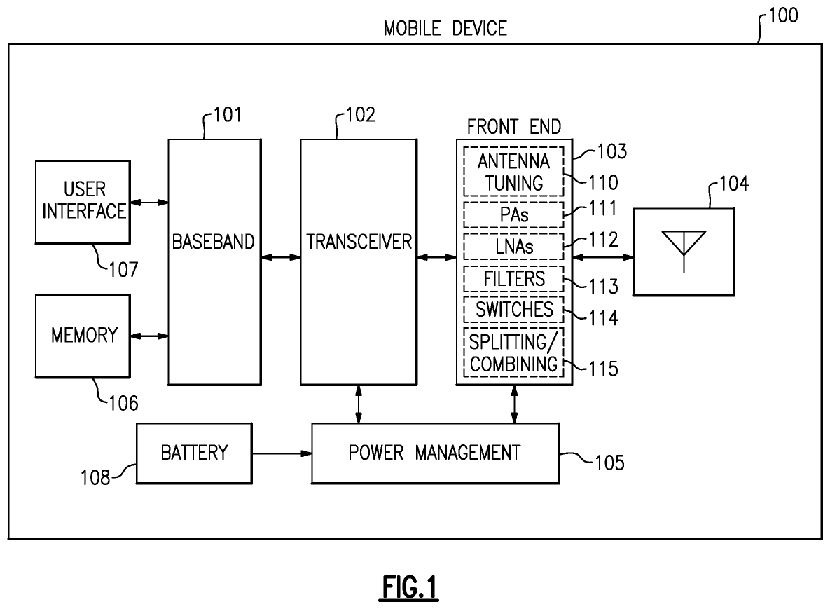

Examples of the disclosure may relate to communication modules having front-end modules (FEMs) implemented in connection with one or more communication devices, such as mobile communication devices. FIG. 1 illustrates a schematic diagram of a mobile communication device 100 according to an example. The mobile device 100 includes a baseband system 101, a transceiver 102, a front-end module 103 (“FEM 103”), antennas 104, a power-management system 105, a memory 106, a user interface 107, and a battery 108.

The mobile device 100 can be used to communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), GPS technologies, and/or other communications technologies.

The transceiver 102 may generate RF signals for transmission via the antennas 104 and process incoming RF signals received from the antennas 104. It will be understood that various functionalities associated with the transmission and receiving of RF signals can be achieved by one or more components that are collectively represented in FIG. 1 as the transceiver 102. In one example, separate components (for instance, separate circuits or dies) can be provided for handling certain types of RF signals.

The FEM 103 aids in conditioning signals transmitted to and/or received from the antennas 104. In the illustrated embodiment, the FEM 103 includes antenna-tuning circuitry 110, power amplifiers (PAs) 111, low-noise amplifiers (LNAs) 112, filters 113, switches 114, and signal splitting/combining circuitry 115. However, other implementations are possible. The filters 113 can include one or more filter circuits with harmonic rejection that include one or more features of the examples disclosed herein. In some examples, the FEM 103 may be a FEM system having multiple FEMs.

The FEM 103 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), transmitting and/or receiving SRS signals, or some combination thereof.

The antennas 104 can include antennas used for a wide variety of types of communications. For example, the antennas 104 can include antennas for transmitting and/or receiving signals associated with a wide variety of frequencies, including RF signals, and communications standards.

The antennas 104 may include one or more antennas. In certain implementations, the antennas 104 support Multiple Input Multiple Output (MIMO) communications and/or switched diversity communications. For example, MIMO communications use multiple antennas for communicating multiple data streams over a single radio-frequency channel. MIMO communications benefit from higher signal-to-noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal-strength indicator.

The baseband system 101 is coupled to the user interface 107 to facilitate processing of various user input and output (I/O), such as voice and data. The baseband system 101 provides the transceiver 102 with digital representations of transmit signals which the transceiver 102 processes to generate RF signals for transmission. The baseband system 101 also processes digital representations of received signals provided by the transceiver 102. As shown in FIG. 1, the baseband system 101 is coupled to the memory 106 to facilitate operation of the mobile device 100.

The memory 106 can be used for a wide variety of purposes, such as storing data and/or instructions to facilitate the operation of the mobile device 100 and/or to provide storage of information, such as user information. In some examples, the memory 106 may be coupled to at least one controller configured to control operation of the mobile device 100. For example, the mobile device 100 may include the at least one controller. The at least one controller may be coupled to one or more components of the mobile device 100 and, in some examples, the mobile device 100 includes the at least one controller. The memory 106 may include one or more non-transitory computer-readable media configured to store instructions, which the at least one controller may be configured to read to operate the mobile device 100.

The power-management system 105 provides a number of power-management functions of the mobile device 100. In certain implementations, the power-management system 105 includes a PA-supply control circuit which controls the supply voltages of the power amplifiers 111. For example, the power-management system 105 can be configured to change the supply voltage(s) provided to one or more of the power amplifiers 111 to improve efficiency, such as power-added efficiency (PAE).

As shown in FIG. 1, the power-management system 105 receives a battery voltage from the battery 108. The battery 108 can be any suitable battery for use in the mobile device 100, including, for example, a lithium-ion battery.

In one example, the FEM 103 may support sounding reference signal (SRS) functionality to provide an estimate or characterization of the uplink (that is, transmit) channel quality over a wide bandwidth. In some examples, the SRS is an RF signal. The FEM 103 may transmit an SRS to a base station and the base station may utilize or analyze the received SRS to estimate channel quality and determine resource (for example, channel) allocations. In some examples, the SRS may provide information corresponding to multipath fading, scattering, Doppler effects, power loss, and other radio frequency transmission characteristics. In certain cases, the FEM 103 may be configured as a 5G system and may utilize SRS functionality to support 5G communication. In some cases, SRS support on each TX/RX antenna of the FEM 103 (for example, antenna 104) may be a requirement and/or may be desirable for 5G systems (or devices).

In many cases, wireless-communication devices include multiple FEMs. The multiple FEMs may be included in a FEM system having an integrated SRS implementation. To support full SRS functionality, the transmit path(s) of each FEM may be connected to the transmit/receive path(s) of each other FEM of the FEM system via respective ports (or pins). As such, each FEM of the FEM system (including, for example, FEM 103) may include a multi-port (or pin) SRS interface. For example, the FEM 103 may include an input SRS port to receive an SRS from another FEM included in the FEM system. Likewise, the FEM 103 may include an output SRS port to provide an SRS to another FEM included in the FEM system.

With the implementation of 5G systems, linearity requirements for the FEMs are getting more challenging. In at least some embodiments described herein additional harmonic filtering is provided to improve the linearity of an FEM.

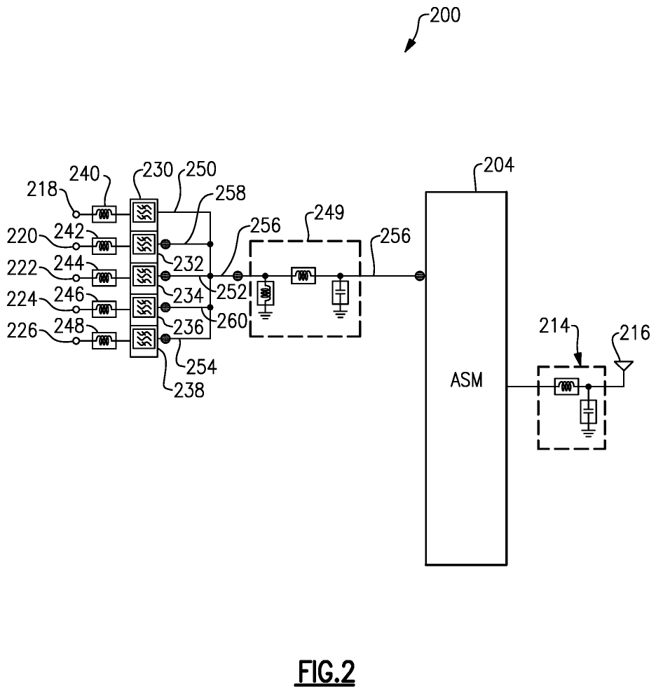

FIG. 2 illustrates a block diagram of a FEM 200 according to an example. The FEM 200 is coupled to an output antenna port 216 through an antenna filter 214. In some examples, one or more FEMs 200 may be included in a wireless-communication device, such as the mobile device 100. For example, the FEM 200 may be an implementation of the FEM 103. For purposes of example, the FEM 200 is illustrated in a two-transmit three-receive arrangement. It is appreciated that this arrangement is illustrated for purposes of example only, and that different arrangements are within the scope of the disclosure.

The FEM 200 includes an antenna switch module (ASM) 204, an antenna filter 214 and an antenna port 216. The FEM 200 also includes a number of ports including a first receive port 218 (or pin), a first transmit port 220 (or pin), a second receive port 222 (or pin), a second transmit port 224, and a third receive port 226 (or pin). The FEM 200 also includes a number of acoustic wave filters 230, 232, 234, 236, and 238, and inductors 240, 242, 244, 246, and 248. The acoustic wave filters may be incorporated in one of a transmit module and a receive module. Each acoustic wave filter 230, 232, 234, 236 and 238 is coupled to a respective one of the ports 218, 220, 222, 224 and 226 through a respective inductor 240. 242, 244, 246, and 248. Each of the first receive port, the second receive port and the third receive port are configured to provide signals received at the antenna port 216, and each of the first and second transmit ports are configured to receive transmit signals and provide the transmit signals to the antenna port 216. The FEM also includes a common filter 249 disposed in a transmit/receive path 256 between each of the acoustic wave filters and the antenna switching module. The common filter 249 functions mainly as an impedance matching network. Each of the acoustic wave filters 230, 234, and 238 is coupled to a receive port on one end and a receive path 250, 252, and 254 on another end, with each of the receive paths also being coupled to the transmit/receive path 256. Each of the acoustic wave filters 232, 236 is coupled to a transmit port on one end and a transmit path 258, 260 on another end, each of the transmit paths also being coupled to the transmit/receive path 256.

Each of the receive and transmit ports and the acoustic wave filters are configured to operate at a particular frequency, identified as Fo, within the range of 5G Mid/Low Band (MLB) frequencies. In operation, the FEM 200 operates in a receive mode and in a transmit mode. In a transmit mode, a transmit signal is received at one of the transmit ports 220, 224. The signal is passed through one of the acoustic wave filters to one of the transmit paths 258, 260 and through the transmit/receive 256 path to the antenna switching module 204 and then to the antenna port 216. The antenna switching module is controllable to selectively couple the transmit/receive path 256 to the antenna port 216. In a receive mode, a receive signal is received at the antenna port 216 and passed to the antenna switching module 204. The antenna switching module can couple the antenna port 216 to the transmit/receive path 256 to pass the receive signal to each of the receive paths 250, 252, and 254 and to the receive ports 218, 222, and 226. In at least some embodiments, each of the acoustic wave filters 230, 234 and 238 coupled to the receive ports is tuned for a particular frequency and may not pass all received signals to a corresponding receive port.

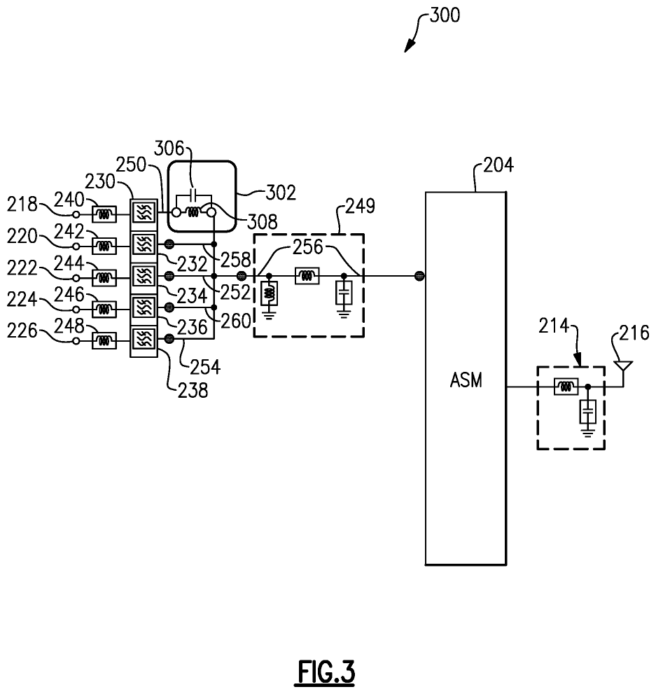

As previously discussed, with the implementation of 5G systems, linearity requirements for FEMs are getting more challenging. As will now be described, a FEM 300 shown in FIG. 3 provides additional harmonic filtering over the FEM 200 described above. The FEM 300 is similar to the FEM 200 described above and like components are labelled using the same reference numbers. In the FEM 300 an additional filter 302 is added in the receive line 250. In the embodiment shown in FIG. 3, the filter is a series LC tank circuit including a capacitive element 306 coupled in parallel with an inductive element 308. In other embodiments, the filter may be implemented using other filter topologies. In at least one embodiment, the capacitor 306 of the filter 300 may be implemented using a surface mount technology (SMT) capacitor, may be a printed circuit capacitor, or may be a SAW/BAW acoustic resonator.

The FEM 300 operates in a manner similar to that of FEM 200 described above in the receive mode of operation. The transmit mode of operation of FEM 300 is also substantially the same as described above for FEM 200 with the exception that the filter 302 will act to filter a second harmonic signal H2 from a transmit signal from either transmit path 258, 260. The impedance of the filter 302 is tuned towards open at a frequency twice that of a transmit signal on either transmit path 258 or 260 to reduce the level of the second harmonic of the transmit signal. A particular advantage provided by the filter 302 is that it provides attenuation of the second harmonic of a transmit signal without being in the direct transmit path of the transmit signal, essentially eliminating any insertion loss at the fundamental frequency of the transmit signal.

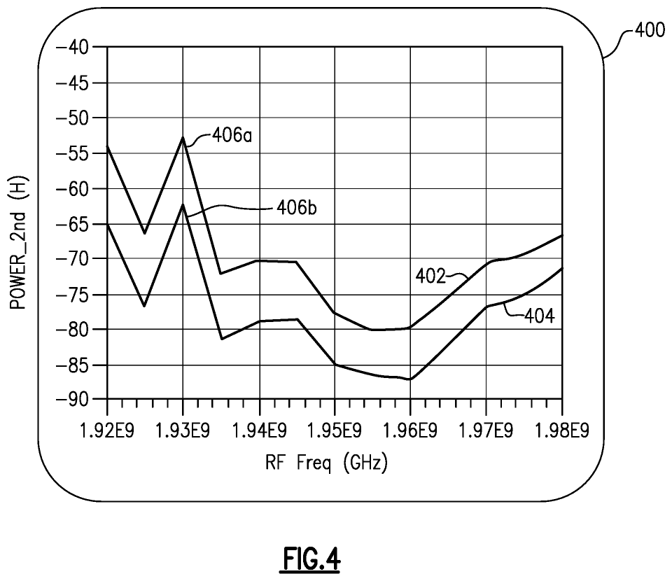

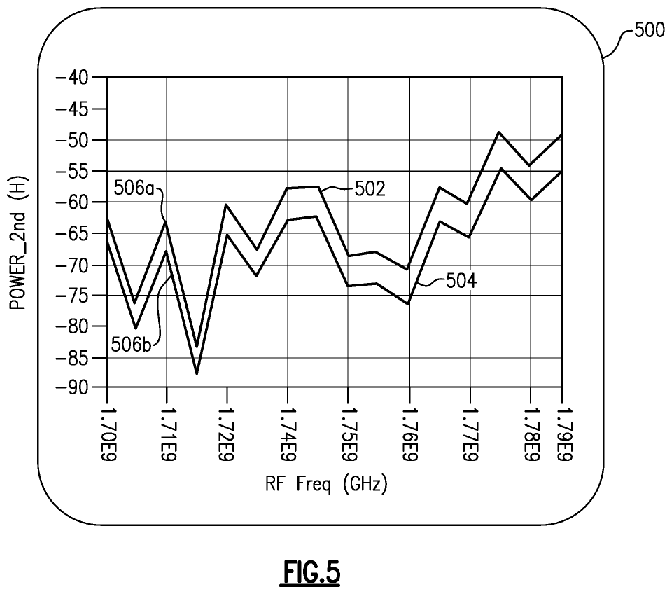

In one example of operation of the FEM 300, the acoustic wave filter 236 is tuned to operate in the 5G BITx band (1920-1980 MHZ), the acoustic wave filter 232 is tuned to operate in the 5G B3Tx band (1710-1785 MHZ), the acoustic wave filter 238 is tuned to operate in the 5G B1Rx band (2110-2170 MHZ), the acoustic wave filter 234 is tuned to operate in the 5G B3Rx band 1805-1880 MHZ), and the acoustic wave filter 230 is configured to operate in the LTE B32Rx band (1452-1496 MHZ). FIG. 4 shows a graph 400 of the signal level of a BITx signal at the antenna port 216. The upper trace 402 shows the transmit signal at the antenna port without the filter 302 in place (FEM 200), and the lower trace 404 shows the signal level of the BITx signal at the antenna port 216 with the filter 302 in place (FEM 300). At the second harmonic 406a, 406b, the signal is reduced 10 dB with the filter 302 in place. Similarly, FIG. 5 shows a graph 500 of the signal level of a B3Tx signal at the antenna port 216. The upper trace 502 shows the level of the transmit signal at the antenna port 216 without the filter 302 in place (FEM 200), and the lower trace 504 shows the level of the transmit signal at the antenna port with the filter 302 in place (FEM 300). At the second harmonic 506a, 506b, the signal is reduced 6 dB with the filter 302 in place. As shown in FIGS. 4 and 5, the use of the filter 302 results in a reduction of the second harmonic of transmit signals at the antenna port.

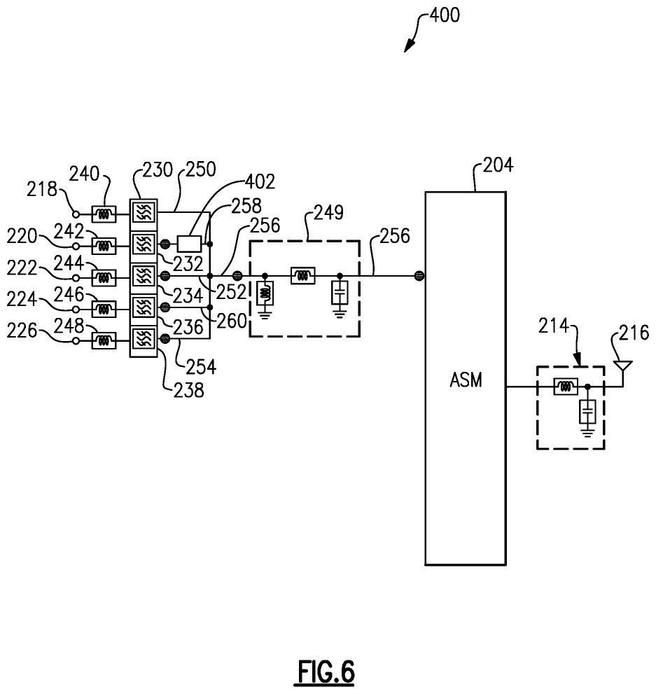

Another embodiment of a FEM 400 with improved filtering will now be described with reference to FIG. 6. The FEM 400 is similar to the FEM 200 described above and like components are labelled using the same reference numbers. In the FEM 400 an additional filter 402 is added in the transmit line 258. In the embodiment shown in FIG. 6, the filter is a series LC tank circuit tuned to provide a high impedance at a frequency that is twice the fundamental frequency of the intended transmit signal from the transmit line 258. In other embodiments, the filter may be implemented using other filter topologies. In at least one embodiment, the capacitor of the filter 400 may be implemented using a surface mount technology (SMT) capacitor, maybe a printed circuit capacitor, or maybe a SAW/BAW acoustic resonator. In operation of the FEM 400, the filter 402 will present a low impedance to the fundamental frequency allowing the intended signal to go directly to the antenna port, and the filter 402 will provide a high impedance at twice the fundamental frequency causing the second harmonic to be reflected with little energy at the second harmonic passing to the antenna port.

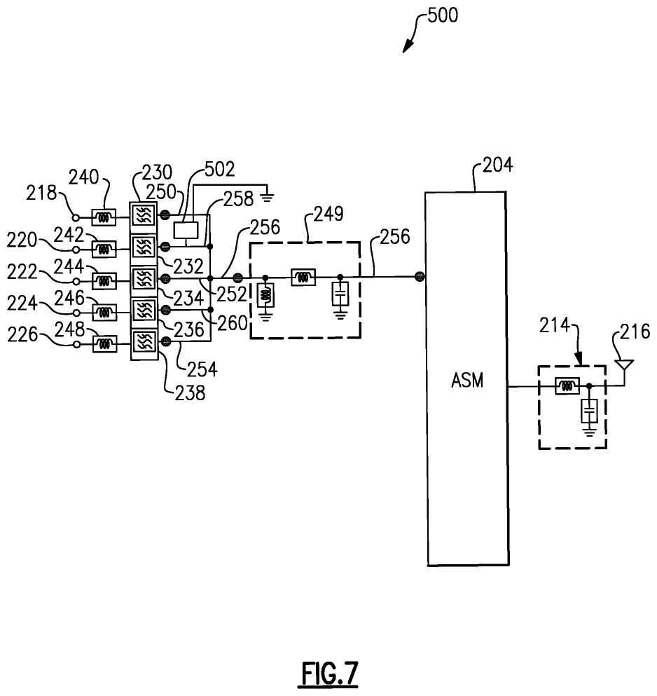

Another embodiment of a FEM 500 with improved filtering will now be described with reference to FIG. 7. The FEM 500 is similar to the FEM 200 described above and like components are labelled using the same reference numbers. In the FEM 500 an additional filter 502 is added between the transmit line 258 and ground. In the embodiment shown in FIG. 7, the filter is a series LC tank circuit tuned to provide a low impedance at a frequency that is twice the fundamental frequency of the intended transmit signal from the transmit line 258, and the filter provides a high impedance to the fundamental frequency. In other embodiments, the filter may be implemented using other filter topologies. In at least one embodiment, the capacitor of the filter 502 may be implemented using a surface mount technology (SMT) capacitor, maybe a printed circuit capacitor, or maybe a SAW/BAW acoustic resonator. In operation of the FEM 500, the filter 502 will present a high impedance to the fundamental frequency such that the intended signal will pass directly to the antenna port without any insertion losses from the filter 502, The filter 502 will provide a low impedance at twice the fundamental frequency causing the second harmonic to be shunted to ground with little energy at the second harmonic passing to the antenna port.

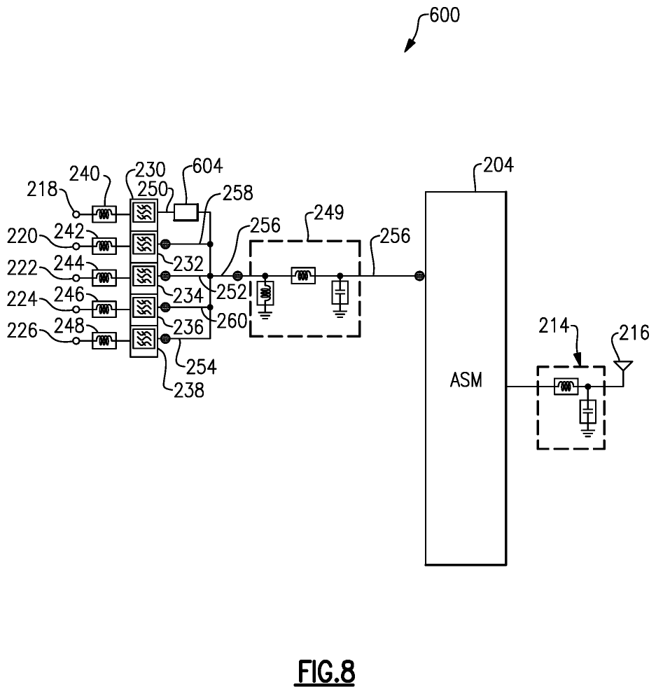

Another embodiment of a FEM 600 with improved filtering will now be described with reference to FIG. 8. The FEM 600 is similar to the FEM 200 described above and like components are labelled using the same reference numbers. In the FEM 600 a transmission line 604 is added in the receive line 250. In one embodiment, the transmission line is designed to rotate the impedance such that the filter 230 presents a low impedance to the second harmonic on the transmit line 258 and a high impedance at the fundamental frequency.

While the above examples use specific 4G and 5G bands to demonstrate improved filtering of the second harmonic of transmit signals, in other examples, other transmit frequencies can be used with embodiments disclosed herein to achieve reduction of harmonic signals, including those other than the second harmonic.

It should be appreciated that while the FEMs 200, 300, 400, 500 and 600 have been described above with reference to various 4G and 5G cellular applications, similar FEM architectures may be used in different wireless applications. For example, the FEMs may be configured for use in wireless local area network (WLAN), ultra-wideband (UWB), wireless personal area network (WPAN), 4G cellular, LTE cellular applications, and so forth. In addition, the single-port interfaces of each FEM may be configured for different calibration or characterization purposes corresponding to the specific application of use.

In some examples, one or more components of the FEMs 200, 300, 400, 500, 600 such as the power amplifiers may include gallium arsenide (GaAs) heterojunction bipolar transistors (HBT) and/or silicon germanium (SiGe) HBTs. In certain examples, the FEMs or one or more components of the FEMs may be fabricated using silicon-on-insulator (SOI) techniques.

Embodiments of the FEMs described herein may be advantageously used in a variety of electronic devices. Examples of the electronic devices can include, but are not limited to, consumer electronic products, parts of consumer electronic products, electronic test equipment, cellular communications infrastructure such as a base station, etc. Examples of the electronic devices can include, but are not limited to, a router, a gateway, a mobile phone such as a smart phone, a telephone, a television, a computer monitor, a computer, a modem, a hand-held computer, a laptop computer, a tablet computer, an electronic book reader, a wearable computer such as a smart watch, a personal digital assistant (PDA), an appliance, such as a microwave, refrigerator, or other appliance, an automobile, a stereo system, a DVD player, a CD player, a digital music player such as an MP3 player, a radio, a camcorder, a camera, a digital camera, a portable memory chip, a health-care-monitoring device, a vehicular electronics system such as an automotive electronics system or an avionics electronic system, a peripheral device, a wrist watch, a clock, etc. Further, the electronic devices can include unfinished products.

It is to be appreciated that example FEMs and FEM systems provided herein are provided for purposes of explanation. In some examples, certain FEMs and/or FEM systems may include additional, fewer, or different components than those illustrated. Certain FEMs and/or FEM systems may include additional components that have not been illustrated for purposes of clarity. For example, one or more of the FEM systems may include an interface configured according to the Mobile Industry Processor Interface (MIPI) standard and having one or more ports or pins, one or more voltage input or output ports or pins, one or more filters, one or more amplifiers (including, for example, PAs, LNAs, and so forth), one or more coupling elements, one or more coupler ports or pins, one or more resistors, inductors, and/or capacitors, one or more switches, and so forth.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A front-end module for a wireless device comprising:
at least one transmit path configured to receive a first transmit signal;
at least one receive path configured to receive a first receive signal;
at least one transmit/receive path, coupled to the at least one receive path and to the at least one transmit path;
an antenna switching module coupled between the at least one transmit/receive path and an antenna port; and
a first transmit filter disposed in at least one of the at least one transmit path and the at least one receive path and configured to reduce harmonic content from the first transmit signal.

2. The front-end module of claim 1 wherein the first transmit filter includes an inductive/capacitive tank circuit.

3. The front-end module of claim 2 wherein a capacitive element of the inductive/capacitive tank circuit includes one of a surface mount capacitor and an acoustic wave resonator.

4. The front-end module of claim 1 wherein the first transmit filter is disposed in a first transmit path of the at least one transmit path, the front-end module further including a receive filter disposed in the at least one receive path and a second transmit filter disposed in the transmit/receive path.

5. The front-end module of claim 4 wherein the front-end module is configured to support 5G wireless communication, the receive signal is a mid band 5G signal, and the first transmit signal is a mid band 5G signal.

6. The front-end module of claim 1 wherein the antenna switch module is configured to selectively couple the transmit/receive path to the antenna port.

7. The front-end module of claim 1 wherein the first transmit filter is disposed in the at least one receive path.

8. The front-end module of claim 1 wherein the first transmit filter is disposed in the at least one transmit path.

9. A mobile communications device system comprising:
a receive module;
a first transmit module;
a first transmit path coupled to the first transmit module and configured to receive a first transmit signal from the first transmit module;
a receive path coupled to the receive module and configured to provide a receive signal to the receive module;
at least one transmit/receive path, coupled to the receive path and the at least one transmit path; and
a first transmit filter disposed in the receive path and configured to reduce harmonic content from the first transmit signal.

10. The mobile communications device system of claim 9 further comprising an antenna switching module coupled between the at least one transmit/receive path and an antenna port.

11. The mobile communications device system of claim 10 further comprising a second transmit module and a second transmit path coupled to the second transmit module and to the at least one transmit/receive path, wherein the second transmit module is configured to provide a second transmit signal to the second transmit path.

12. The mobile communication device system of claim 11 wherein the first transmit filter is configured to reduce harmonic content from the second transmit signal.

13. The mobile communications device system of claim 12 wherein the mobile communications device system is configured to support 5G wireless communication.

14. The mobile communication device system of claim 9 wherein the receive module includes at least one low-noise amplifier.

15. The mobile communications device system of claim 10 further comprising a second transmit filter disposed in the transmit/receive path.

16. A method for controlling a front-end module for a wireless device including at least one transmit path to receive a first transmit signal, at least one transmit/receive path coupled to at least one antenna port, and an antenna switching module disposed in the at least one transmit path, the wireless device also including at least one receive path coupled to the at least one transmit/receive path, the method comprising:
filtering at least one harmonic from the transmit signal using a filter disposed in one of the transmit path and the receive path; and
controlling the antenna switching modules to route the transmit signal from the transmit/receive path to the antenna port.

17. The method of claim 16 wherein the filter is disposed in the receive path, the method further comprising receiving a receive signal at the at least one antenna port and routing the receive signal to the receive path and through the filter in the receive path.

18. The method of claim 17 further comprising receiving a second transmit signal on the transmit path and filtering at least one harmonic from the second transmit signal using the filter in the receive path.

19. The method of claim 16 wherein filtering at least one harmonic from the transmit signal includes filtering the at least one harmonic using a filter that includes an acoustic resonator.

20. The method of claim 16, wherein filtering at least one harmonic from the transmit signal includes filtering the at least one harmonic using a filter includes using a filter that includes a surface mount capacitor.
